(19) United States
(12) Patent Application Publication
(10) Pub. No.: US 2020/0129363 A1
(43) Pub. Date: Apr. 30, 2020

(54) FINGER REHABILITATION EXERCISE GUIDE APPARATUS

(71) Applicant: Seoul National University R&DB Foundation, Seoul (KR)

(72) Inventors: Seok Won Kang, Gwangju-si (KR); Jung Ho Kim, Seoul (KR); Yoon Young Kim, Seoul (KR)

(21) Appl. No.: 16/243,260

(22) Filed: Jan. 9, 2019

(30) Foreign Application Priority Data
Oct. 31, 2018 (KR) 10-2018-0132223

(51) Int. Cl. A61H 1/02

(52) U.S. Cl. CPC A61H 1/0288; A61H 2201/1676; A61H 2201/1638

(57) ABSTRACT

Disclosed is a finger rehabilitation exercise guide apparatus, which is driven through a linear actuator to have a compact layout in an outer surface direction from an operation direction and is configured in such a way that a position of a prismatic joint in an inner surface layout of the operation direction is changeable by a designer, and as necessary, one prismatic joint, one revolute joint, and a link having opposite ends connected with a corresponding prismatic joint and revolute joint are replaced with one pin-in-slot joint while freely changing the position of the prismatic joint, to realize a small number of components and to precisely guide movement of the wearer's finger.

### CROSS-REFERENCE TO RELATED APPLICATION

This application claims priority to and the benefit of Korean Patent Application No. 10-2018-0132223 filed in the Korean Intellectual Property Office on Oct. 31, 2018, the entire contents of which are incorporated herein by reference.

### BACKGROUND OF THE INVENTION

### (a) Field of the Invention

The present invention relates to a finger rehabilitation exercise guide apparatus.

### (b) Description of the Related Art

In general, stroke patients have difficulty in moving their fingers according to their intention due to damage to the nervous system. They are capable of recovering from the damage to the nervous system and are capable of gradually recovering capability of moving fingers through rehabilitation exercise of repeatedly moving their fingers.

Recently, finger exoskeleton robot devices for systematically helping with the rehabilitation exercise without help of an attendant have been developed. For precise rehabilitation of the fingers, the posture and position of the fingers need to be guided. Since the finger has a complex skeletal structure, robots using a plurality of actuators have been developed, but this is disadvantageous in that practicality of the robots is degraded due to a high price and a complex control algorithm that is required.

Recently, 1 degree of freedom linkage devices for applying appropriate resistance force or assistive force while precisely guiding the posture and position of the fingers via a simple control algorithm using only one actuator have been developed. However, conventional 1 degree of freedom linkage devices have disadvantages in that an additional instrument chain needs to be introduced during use of a linear actuator to increase the number of instrumental components, and that a change in layout of instrumentals is limited because movement of the finger as a guidance target is changed when an installable space of instruments is changed to change a position of a joint.

Accordingly, there is a need to develop a 1 degree of freedom finger rehabilitation linkage mechanism including a plurality of prismatic joints to freely change a layout depending on cases and to enable addition of a linear actuator without addition of an instrument chain.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides a finger rehabilitation exercise guide apparatus, which is driven through a linear actuator to have a compact layout in an outer surface direction from an operation direction, that changes a position of a prismatic joint in an inner surface layout of the operation direction, and as necessary, one prismatic joint, one revolute joint, and a link having opposite ends connected with a corresponding prismatic joint and revolute joint are replaced with one pin-in-slot joint while freely changing the position of the prismatic joint, to realize a small number of components and to precisely guide movement of the wearer's finger.

According to an embodiment of the present invention, a finger rehabilitation exercise guide apparatus may include a first support coupled to a proximal phalanx positioned between a first joint (metacarpophalangeal (MCP)) and a second joint (proximal interphalangeal (PIP)) of a finger with three joints and three segments, a second support coupled to an intermediate phalanx positioned between the second joint and a third joint (distal interphalangeal (DIP)), a first link having one side supporting a hand with fingers and the other side supported by a palm and functioning as a reference with respect to overall movement of a link structure, an actuator for generating driving force transmitted to the first support and the second support from the first link, a first transmitter including a plurality of links connected with each other in different shapes between the first support and the first link, some revolute joint of a plurality of revolute joints, and a plurality of prismatic joints, and transmitting the driving force of the actuator to the first support, and a second transmitter for sharing the plurality of links connected with each other in different shapes between the second support and the first link, a plurality of revolute joints, and the plurality of prismatic joints, and transmitting the driving force of the actuator to the second support.

The plurality of links may include: a second link having one side coupled to a sixth link through a fourth prismatic joint, another side coupled to a seventh link through a fifth prismatic joint, another side coupled to a third link through a first prismatic joint, and another side coupled to a fourth link through a second revolute joint;

a third link having one side coupled to a second link through a first prismatic joint, another side coupled to the second support through a fourth revolute joint, and another side coupled to an eighth link through a third prismatic joint;

a fourth link having one side coupled to the second link through the second revolute joint, another side coupled to the first support through a fixed joint, and another side coupled to a fifth link through a second prismatic joint;

a fifth link having one side coupled to the fourth link through a second prismatic joint and the other side coupled to the third link through a third revolute joint;

a sixth link having one side coupled to the first link through a fifth revolute joint and the other side coupled to the second link through the fourth prismatic joint;

a seventh link having one side coupled to the first link through a sixth revolute joint and the other side coupled to the second link through a fifth prismatic joint; and

an eighth link having one side coupled to the first link through a first revolute joint and the other side coupled to the third link through a third prismatic joint.

The plurality of revolute joints may include the first revolute joint for connection of the first link and the eighth link, the second revolute joint for connection of the second link and the fourth link, the third revolute joint for connection of the third link and the fifth link, the fourth revolute joint for connection of the third link and the second support, the fifth revolute joint for connection of the first link and the sixth link, and the sixth revolute joint for connection of the first link and the seventh link.

The plurality of prismatic joints may include the first prismatic joint for connection of the third link and the second link, the second prismatic joint for connection of the fourth link and the fifth link, the third prismatic joint for connection of the third link and the eighth link, the fourth prismatic joint for connection of the second link and the sixth link, and the fifth prismatic joint for connection of the second link and the seventh link.

To reduce the number of components constituting the instrument, links having opposite sides coupled to other links through a revolute joint and a prismatic joint may be replaced with a pin-in-slot joint.

For example, the sixth link, the fifth revolute joint, and the fourth prismatic joint may be replaced with a first pin-in-slot joint. The first pin-in-slot joint may be embodied by coupling a first pin included in the first link to a first slot included in the second link.

The seventh link, the sixth revolute joint, and the fifth prismatic joint may be replaced with the second pin-in-slot joint. The second pin-in-slot joint may be embodied by coupling the second pin included in the first link to the second slot included in the second link.

The eighth link, the first revolute joint, and the third prismatic joint may be replaced with the third pin-in-slot joint. The third pin-in-slot joint may be embodied by coupling the third pin included in the first link to the third slot included in the third link.

The fifth link, the third revolute joint, and the second prismatic joint may be replaced with the fourth pin-in-slot joint.

The fourth pin-slot joint may be embodied by coupling the fourth pin included in the third link to the fourth slot included in the fourth link.

Some of revolute joints, prismatic joints, and links, which are selected from a plurality of revolute joints, a plurality of prismatic joints, and a plurality of links connected to the plurality of revolute joints or the plurality of prismatic joints, may be replaced with a rotary actuator or a linear actuator to be driven.

The first prismatic joint may be replaced with a linear actuator having one side coupled to the second link through a fixed joint and the other side coupled to the third link through a fixed joint.

The second prismatic joint and the fifth link may be replaced with a linear actuator having one side coupled to the fourth link through the fixed joint and the other side coupled to the third link through the third revolute joint.

The third prismatic joint and the eighth link may be replaced with a linear actuator having one side coupled to the third link through the fixed joint and the other side coupled to the first link through the first revolute joint.

The fourth prismatic joint and the sixth link may be replaced with a linear actuator having one side coupled to the second link through the fixed joint and the other side coupled to the first link through the fifth revolute joint.

The fifth prismatic joint and the seventh link may be replaced with a linear actuator having one side coupled to the second link through the fixed joint and the other side coupled to the first link through the sixth revolute joint.

The first revolute joint and eighth link may be replaced with a rotary actuator having one side coupled to the first link through the fixed joint and the other side coupled to the third link through the third prismatic joint.

The second revolute joint may have one side coupled to the second link through the fixed joint and the other side coupled to the fourth link through the fixed joint.

The third revolute joint and the fifth link may be replaced with a rotary actuator having one side coupled to the third link through the fixed joint and the other side coupled to the fourth link through a second prismatic joint.

The fifth revolute joint and the sixth link may be replaced with a rotary actuator having one side coupled to the first link through the fixed joint and the other side coupled to the second link through the fourth prismatic joint.

The sixth revolute joint and the seventh link may be replaced with a rotary actuator having one side coupled to the first link through the fixed joint and the other side coupled to the second link through the fifth prismatic joint.

A linear spring, a rotation spring, a linear damper, or a rotation damper may be additionally installed in each joint to apply resistance force to the finger of a wearer.

An instantaneous center of rotation with respect to the first link of the fourth link coupled to a first support coupled to a proximal phalanx of the wearer finger through the fixed joint may be adjacent to a first joint of the wearer finger, in a desired driving range.

A straight line for connection of an instantaneous center of rotation with respect to the fourth link of the third link coupled to the second support coupled to the intermediate phalanx of the wearer finger through the fourth revolute joint with the fourth revolute joint may be adjacent to the second joint in a desired driving range.

A revolute joint and a prismatic joint may be used, and as necessary, a position of the prismatic joint may be freely adjusted while maintaining an output path of a finger rehabilitation exercise guide apparatus to change a layout and to replace the prismatic joint with a mechanical component.

Since a revolute joint and a prismatic joint are used, even if an additional instrument chain is not introduced, one of joints may be replaced with an actuator to easily add a rotary actuator or a linear actuator.

Other mechanical components such as a spring or a damper may also be added to a position of a revolute joint or a prismatic joint, or may be replaced with a corresponding joint according to the characteristics of the component.

In addition, a link having two opposite ends that are connected with other links through a revolute joint and a prismatic joint, respectively and a corresponding revolute joint and prismatic joint may be replaced with one pin-in-slot joint to reduce the number of mechanical components constituting the instrument.

### BRIEF DESCRIPTION OF THE DRAWINGS

FIG. 1A is a schematic diagram showing the anatomical structure of a finer for aiding in understanding of a finger rehabilitation exercise guide apparatus according to an exemplary embodiment of the present invention.

FIG. 1B is a schematic diagram showing the general movement of a finger of FIG. 1A.

FIG. 2 is a schematic diagram showing a coupling relationship between links of a link structure of a finger rehabilitation exercise guide apparatus and a coupling relationship between the link and the finger.

FIG. 3A is a diagram showing the 21^{st} instantaneous center of rotation 670 of FIG. 2.

FIG. 3B is a diagram showing the second link is instantaneously connected with the first link using a revolute joint at a position of the 21^{st} instantaneous center of rotation.

FIG. 3C is a diagram showing a movement of the second link of FIG. 3B.

FIG. 4 is diagram showing a coupled state of main revolute joints, prismatic joints, and fixed joints of a finger rehabilitation exercise guide apparatus according to an exemplary embodiment of the present invention.

FIG. 5 shows a relationship of points to be guided for finger movement of a wearer to satisfy Equation 2 and points to be guided by the instrument correspond to each other within a specific error in a driving range of a finger rehabilitation exercise guide apparatus according to an exemplary embodiment of the present invention.

FIG. 6 is a diagram showing the case in which a pin-in-slot joint is partially applied to the link structure of FIG. 2.

FIG. 7 is a diagram showing a finger rehabilitation exercise guide apparatus according to an exemplary embodiment of the present invention.

FIG. 8A is a diagram showing the 21^{st} instantaneous center of rotation in the case of θₚ=25°.

FIG. 8B is a diagram showing the 41^{st} moment rotation center in the case of θₚ=25°.

FIG. 8C is a diagram showing a moment Tₐ transmitted to the first support and force Tₐ transmitted to the finger of a wearer in the case of θₚ=25°.

FIG. 9A is a diagram showing the 21^{st} instantaneous center of rotation in the case of θₚ=0°.

FIG. 9B is a diagram showing the 41^{st} moment rotation center in the case of θₚ=0°.

FIG. 9C is a diagram showing a moment Tₐ transmitted to the first support and force Fₐ transmitted to the finger of a wearer in the case of θₚ=0°.

FIG. 10A is a diagram showing the 21^{st} instantaneous center of rotation in the case of θₚ=50°.

FIG. 10B is a diagram showing the 41^{st} moment rotation center in the case of θₚ=50°.

FIG. 100 is a diagram showing a moment Tₐ transmitted to the first support and force Fₐ transmitted to the finger of a wearer in the case of θₚ=50°.

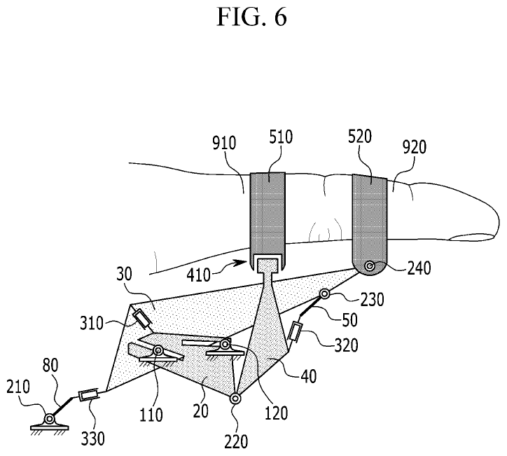

FIG. 11A is a diagram showing an embodiment in which the eighth link, the third prismatic joint, and the first revolute joint are replaced with a third pin-in-slot joint, and the linear actuator is connected with the third link and the second link through a fixed joint and is replaced with the first prismatic joint in the embodiment of FIG. 6.

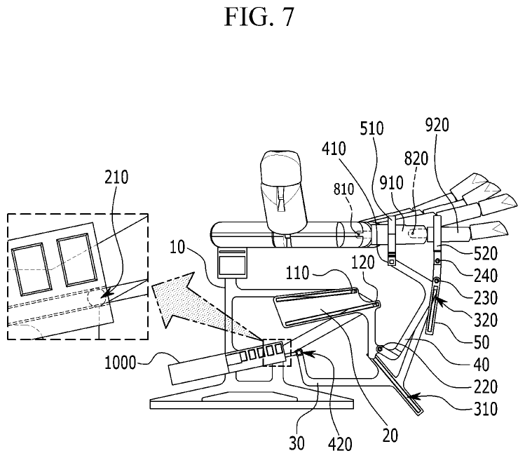

FIG. 11B is a diagram showing an embodiment in which a position of the second prismatic joint is changed in the embodiment of FIG. 7.

### DETAILED DESCRIPTION OF THE EMBODIMENTS

The technical terms used herein are only for the purpose of describing particular embodiments and are not intended to be limiting of the invention. As used herein, the singular forms “a”, “an”, and “the” are intended to include the plural forms as well, unless the context clearly indicates otherwise. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated specific features, regions, integers, steps, operations, elements, and/or components, but do not preclude the presence or addition of other specific features, regions, integers, steps, operations, elements, components, and/or groups thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art, and are not to be interpreted in an idealized or overly formal sense unless expressly so defined herein.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

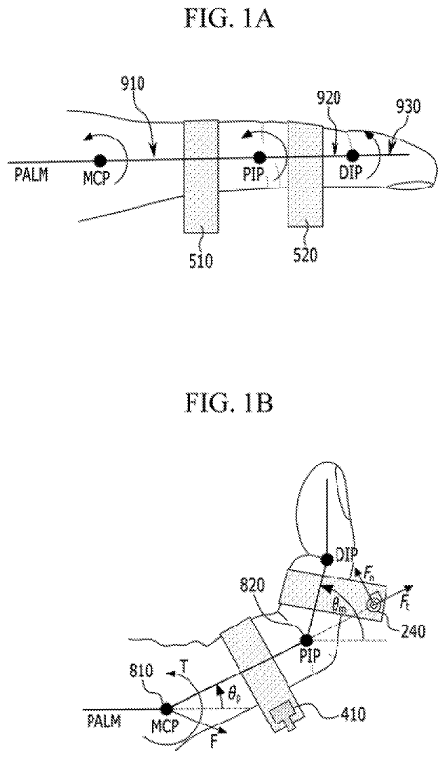

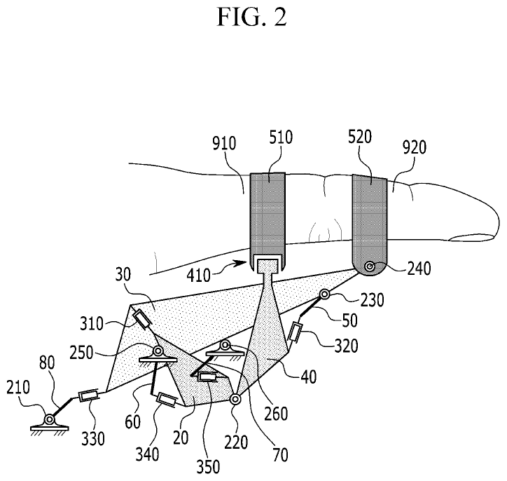

FIG. 1A and FIG. 1B are schematic diagram showing the anatomical structure and general movement of a finger for aiding in understanding of a finger rehabilitation exercise guide apparatus according to an exemplary embodiment of the present invention, and FIG. 2 is a schematic diagram showing a coupling relationship between links of a link structure of a finger rehabilitation exercise guide apparatus and a coupling relationship between the link and the finger. FIG. 6 is a diagram showing the case in which a pin-in-slot joint is applied to the link structure of FIG. 2, and FIG. 7 is a diagram showing a finger rehabilitation exercise guide apparatus according to an exemplary embodiment of the present invention. Referring to FIG. 1A, FIG. 1B, FIG. 2, FIG. 6, and FIG. 7, the finger rehabilitation exercise guide apparatus according to an exemplary embodiment of the present invention may include a first support 510, a second support 520, an actuator, a first transmitter, and a second transmitter. The finger rehabilitation exercise guide apparatus according to an exemplary embodiment of the present invention may include an instrument unit of a device for helping with finger rehabilitation of a stroke patient, it has excellent guidance accuracy of normal finger movement, and it realizes a link structure including both a revolute joint and a prismatic joint. It may be possible to apply a linear actuator using a linkage mechanism including both a revolute joint and a prismatic joint.

The finger rehabilitation exercise guide apparatus according to an exemplary embodiment of the present invention may precisely transmit force of the actuator to each segment of the finger without user inconvenience. For understanding an exemplary embodiment of the present invention, the anatomical structure and general movement of the finger are shown in FIG. 1A and FIG. 1B. The wearable finger may be the second, third, fourth, or fifth finger excluding the thumb. FIG. 1A shows the general finger of a person, and in this case, three segments, i.e., a first segment (proximal phalanx) 910, a second segment (intermediate phalanx) 920, and a third segment (distal phalanx) 930 are connected in series to the palm via three joints, i.e., a first joint (metacarpophalangeal (MCP) joint) 810, a second joint (proximal interphalangeal (PIP) joint) 820, and a third joint (distal Interphalangeal (DIP) joint) 830. When the finger moves, each joint is formed as a revolute joint as shown in FIG. 1B.

The finger rehabilitation exercise guide apparatus according to an exemplary embodiment of the present invention may be an apparatus for transmitting force of the actuator through the first support 510 and the second support 520 which are coupled to two segments of the finger, i.e., the first segment (proximal phalanx) 910 and the second segment (intermediate phalanx) 920. The first support 510 may be rigidly-coupled to the first segment (proximal phalanx) 910 positioned between the first joint (MCP) and the second joint (PIP) of the finger with the three joints and the three segments. The first support 510 may be connected to the instrument unit of the finger rehabilitation exercise guide apparatus through a fixed joint 410.

The second support 520 may be rigidly-coupled to the second segment (intermediate phalanx) positioned between the second joint (PDP) and the third joint (DIP). The second support 520 may be connected to the instrument unit of the finger rehabilitation exercise guide apparatus through a fourth revolute joint 240.

Accordingly, within a driving range, an instantaneous center of rotation of the first support 510 almost matches the first joint (MCP) 810, and the center of a relative path of the second support 520 with respect to the first support 510 may be positioned adjacent to the second joint (PIP) 820. Otherwise, the apparatus may apply force in a direction in which the user finger is not capable of smoothly moving, and thus, a user may be inconvenienced by chafing of the finger. In other words, as shown in FIG. 1B, a moment T having the first joint (MCP) 810 as the center through the fixed joint 410 and a force Fₙ with a direction perpendicular to a line passing through the second joint (PIP) 820 and the fourth revolute joint 240 needs to be applied to the user through the fourth revolute joint 240, and a force in a direction of F or Fₜ should not be generated if possible. This feature may be easily achieved when an apparatus has revolute joints at the same positions as the first joint (MCP) 810 and the second joint (PIP) 820 of the finger. However, when the apparatus and the finger interfere with each other, since the finger is not capable of grasping an object while wearing the apparatus and the volume of the apparatus is increased in a direction except for a direction of an operation surface, it is impossible to allow four fingers to simultaneously wear it, and thus there is a need for an apparatus that satisfies the feature while the apparatus is positioned outside the finger.

One side of the actuator may support the hand with the fingers and the other side of the actuator is supported by the palm, and may be coupled to the first link as a reference with respect to overall movement of the link structure to generate driving force transmitted to the first support and the second support. The actuator may operate a 1 degree of freedom linkage device that does not interfere with the finger within a determined driving range (0°≤θₚ≤60°), and satisfies the feature. In addition, the actuator may be a linear actuator including a prismatic joint to be driven in an inner surface direction for configuring a compact device that occupies a small space in an outer surface direction.

However, as necessary, the opposite sides of the actuator may be coupled to another link that is not the first link. In addition, when the compact device configuration is not required, the actuator may be a rotary actuator including a revolute joint.

The first transmitter may include seven links that have different shapes and are connected with each other between the first support 510 and a first link 10, some revolute joints of a plurality of revolute joints, and five prismatic joints, and may transmit driving force of the actuator to the first support 510. The first transmitter may include seven links, that is, a second link 20, a third link 30, a fourth link 40, a fifth link 50, a sixth link 60, a seventh link 70, and an eighth link 80. In addition, some revolute joints of the plurality of revolute joints may include a first revolute joint 210, a second revolute joint 220, a third revolute joint 230, a fifth revolute joint 250, and a sixth revolute joint 260. The five prismatic joint may include a first prismatic joint 310, a second prismatic joint 320, a third prismatic joint 330, a fourth prismatic joint 340, and a fifth prismatic joint 350.

The second transmitter may include seven links that have different shapes and are connected with each other between the second support 520 and the first link 10, a plurality of revolute joints, and five prismatic joints, and may transmit driving force of the actuator to the second support 520. In the second transmitter, a plurality of revolute joints may include the first revolute joint 210, the second revolute joint 220, the third revolute joint 230, the fourth revolute joint 240, the fifth revolute joint 250, and the sixth revolute joint 260. The five prismatic joints may include the first prismatic joint 310, the second prismatic joint 320, the third prismatic joint 330, the fourth prismatic joint 340, and the fifth prismatic joint 350.

FIG. 2 is a schematic diagram showing a coupling relationship between links of a link structure of a finger rehabilitation exercise guide apparatus and a coupling relationship between the link and the finger. The wearable finger may be the second, third, fourth, or fifth finger excluding the thumb. The link structure may include eight links, six revolute joints, and five prismatic joints. Here, the eight links may include the first link 10 that is a ground link, the second link 20, the third link 30, the fourth link 40, the fifth link 50, a sixth link 60, the seventh link 70, and the eighth link 80. In this case, the first link 10 may be a portion for connection between an installation place of the instrument and the user wrist, and since the first link 10 functions as a reference of movement of the link structure, the first link 10 is omitted in FIG. 2. In addition, the six revolute joints may include the first revolute joint 210, the second revolute joint 220, the third revolute joint 230, the fourth revolute joint 240, the fifth revolute joint 250, and the sixth revolute joint 260. In addition, the five prismatic joints may include the first prismatic joint 310, the second prismatic joint 320, the third prismatic joint 330, the fourth prismatic joint 340, and the fifth prismatic joint 350.

A connection relationship between corresponding links via the revolute joint and the prismatic joint is described below.

The first revolute joint 210 may connect the first link 10 and the eighth link 80 with each other. The second revolute joint 220 may connect the second link 20 and the fourth link 40 with each other. The third revolute joint 230 may connect the third link 30 and the fifth link 50 with each other. The fourth revolute joint 240 may connect the third link 30 and the second support 520 with each other. The fifth revolute joint 250 may connect the first link 10 and the sixth link 60 with each other. The sixth revolute joint 260 may connect the first link 10 and the seventh link 70 with each other.

The first prismatic joint 310 may connect the third link 30 and the second link 20 with each other. The second prismatic joint 320 may connect the fourth link 40 and the fifth link 50 with each other. The third prismatic joint 330 may connect the third link 30 and the eighth link 80 with each other. The fourth prismatic joint 340 may connect the second link 20 and the sixth link 60 with each other. The fifth prismatic joint 350 may connect the second link 20 and the seventh link 70 with each other.

As described above, a degree of freedom of an 8-bar linkage mechanism including the first link 10, the second link 20, the third link 30, the fourth link 40, the fifth link 50, the sixth link 60, the seventh link 70, and the eighth link 80 may be calculated according to Equation 1 using the Gruebler equation.

M=3(N−1)−2J [Equation 1]

Here, M is a degree of freedom (DOF), N is the number of links, and J is the number of joints that allow relative movement of 1 degree of freedom. That is, a degree of freedom of the 8-bar linkage mechanism having eight links, five revolute joints, and five prismatic joints is 1. The fourth revolute joint 240 connects the second support and the 8-bar linkage, and does not constitute the 8-bar linkage. Thus, the fourth revolute joint is excluded from calculation. That is, one of the five prismatic joints, i.e., the first prismatic joint 310, the second prismatic joint 320, the third prismatic joint 330, the fourth prismatic joint 340, or the fifth prismatic joint 350 may be replaced with a linear actuator 1000 to constitute a system that is capable of transmitting force. As necessary, without use of the linear actuator 1000, one of the five revolute joints 210, 220, 230, 250, and 260 may be replaced with a rotary actuator to constitute a system.

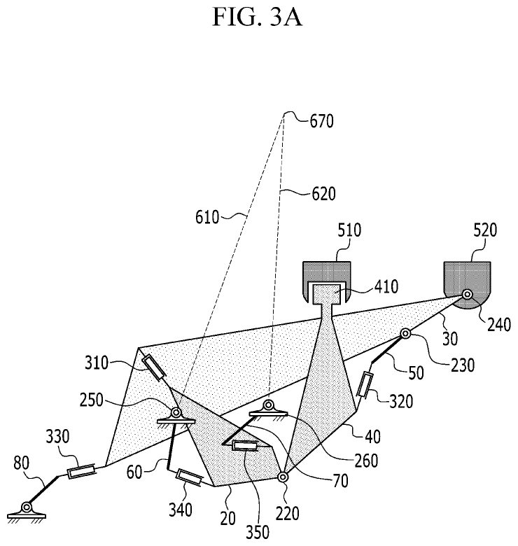

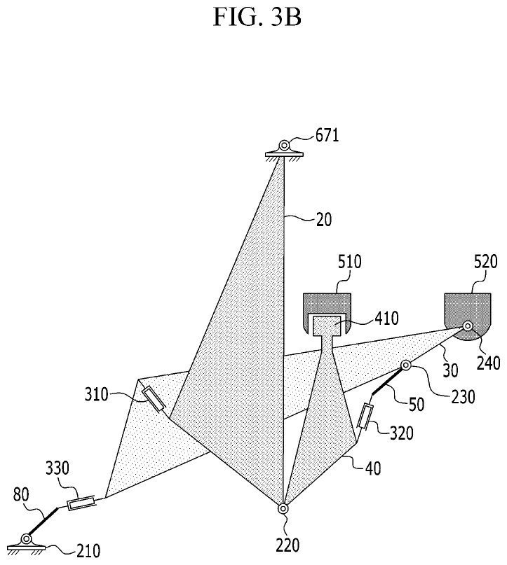

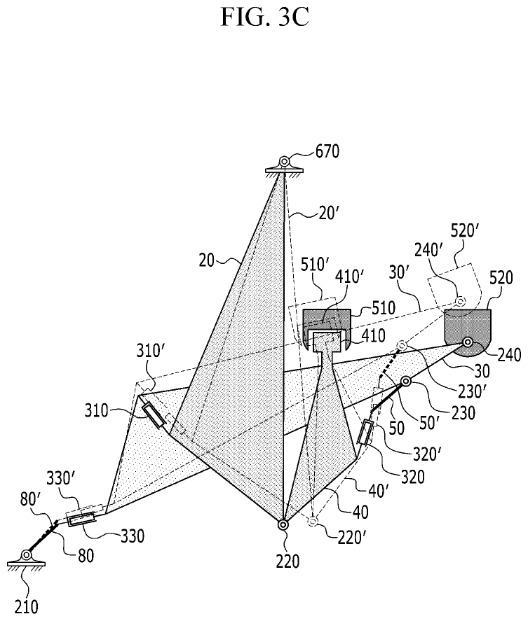

FIG. 3A, FIG. 3B, and FIG. 3C are diagrams showing a principle for transmitting driving force of an actuator of an 8-bar linkage mechanism to the finger of a wearer. The case in which the third prismatic joint 330 is replaced with the linear actuator 1000 has been described. As shown in FIG. 3A, a 21^{st} instantaneous center of rotation 670 with respect to the first link 10 of the second link 20 may be an intersection point between a first vertical line 610 passing through the fifth revolute joint 250 and perpendicular to a guideline to the fourth prismatic joint 340, and a second vertical line 620 passing through the sixth revolute joint 260 and perpendicular to a guideline of the fifth prismatic joint 350. That is, as shown in FIG. 3B, the second link 20 may be considered as a link that is instantaneously connected with the first link 10 using a revolute joint 671 at a position of the 21^{st} instantaneous center of rotation 670. Then, the first link 10 and the second link 20 may be connected with an imaginary revolute joint 671, the second link 20 and the third link 30 may be connected with the first prismatic joint 310, the third link 30 and the eighth link 80 may be connected with the third prismatic joint 330, and the eighth link 80 and the first link 10 may be connected with the first revolute joint 210, and thus, the four links 10, 20, 30, and 80 may constitute a 4-bar linkage of 1 degree of freedom. Accordingly, as shown in FIG. 3C, when the third prismatic joint 330 is driven by the linear actuator 1000 to be moved to a position 330′, the second link 20 may be moved to a position 20′, the third link 30 may be moved to a position 30′, and the eighth link 80 may be moved to a position 80′. Accordingly, the fourth revolute joint 240 may be moved to a position 240′ to exert force to the second support 520 connected therewith in a movement direction. The third link 30 and the fifth link 50 may be connected with the third revolute joint 230, the fifth link 50 and the fourth link 40 may be connected with the second prismatic joint 320, the fourth link 40 and the second link 20 may be connected with the second revolute joint 220, and the second link 20 and the third link 30 may be connected with the first prismatic joint 310, and thus, the four links 30, 50, 40, and 20 may constitute a 4-bar linkage of 1 degree of freedom. Accordingly, as the second link 20 is moved to the position 20′ and the third link 30 is moved to the position 30′, the fourth link 40 may be moved to a position 40′. Accordingly, the fixed joint 410 may be moved to a position 410′, and the first support 510 connected therewith may exert moment based on an instantaneous center of rotation of the fourth link 40.

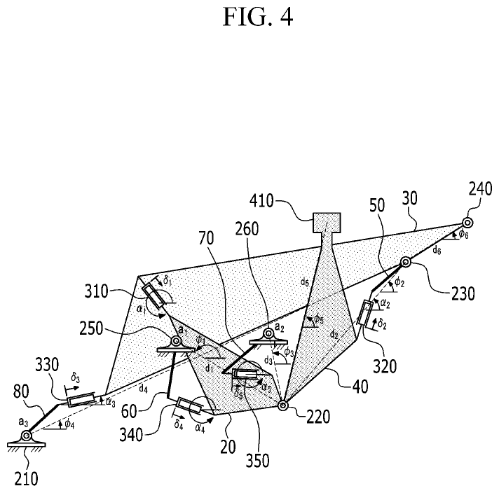

FIG. 4 is a diagram showing dimensions of revolute joints, fixed joints, and prismatic joints for determining movement of a finger guide rehabilitation apparatus. Table 1 below shows dimension values in which moment transmitted to the first support 510 through the fixed joint 410 by the fourth link 40 and force transmitted to the second support 520 through the fourth revolute joint 240 by the third link 30 satisfy a condition of FIG. 1B.

TABLE 1

| | |
|---|---|
| a₁ | (0.5338, 0.3907) |
| a₂ | (0.6548, 0.3167) |
| a₃ | (0.1476, 0.03452) |
| d₁ | 0.3504 |
| d₂ | 0.4885 |
| d₃ | 0.2449 |
| d₄ | 0.9431 |
| d₅ | 0.4843 |
| d₆ | 0.1097 |
| φ₁ | 115.11° |
| φ₂ | 50.2890° |
| φ₃ | 96.4958° |
| φ₄ | 26.0858° |
| φ₅ | 82.2862° |
| φ₆ | 87.1793° |
| α₁ | 310.1109° |
| α₂ | 81.8861° |
| α₃ | 11.8783° |
| α₄ | 12.219° |
| α₅ | 6.3514° |

The dimensions may be determined to satisfy Equation 2 below between θₘ and θₚ of FIG. 1B such that rehabilitation exercise is performed with natural movement of the user finger as well as the condition of FIG. 1B.

θₘ=0.77660232θₚ²+1.37397306θₚ+0.07324267 [Equation 2]

Finger movement satisfying Equation 2 above may be known as finger movement when the finger generally holds an object.

a₁ of FIG. 4 may be a position vector of the fifth revolute joint, a₂ may be a position vector of the sixth revolute joint, a₃ may be a position vector of the first revolute joint, a₁ and φ₁ are a length of a vector connected with the fifth revolute joint 250 from the second revolute joint 220 and a rotation angle in a clockwise direction from the global X axis in an initial state, respectively, d₂ and φ₂ are a length of a vector connected with the third revolute joint 230 from the second revolute joint 220 and a rotation angle in a clockwise direction from the global X axis in an initial state, respectively, d₃ and φ₃ are a length of a vector connected with the sixth revolute joint 260 from the second revolute joint 220 and a rotation angle in a clockwise direction from the global X axis in an initial state, d₄ and φ₄ are a length of a vector connected with the third revolute joint 230 from the first revolute joint 210 and a rotation angle in a clockwise direction from the global X axis in an initial state, respectively, d₅ and φ₅ are a length of a vector connected with the fixed joint 410 from the second revolute joint 220 and a rotation angle in a clockwise direction from the global X axis in an initial state, respectively, d₆ and φ₆ are a length of a vector connected with the fourth revolute joint 240 from the third revolute joint 230 and a rotation angle in a clockwise direction from the global X axis in an initial state, respectively, α₁ is a rotation angle from the global X of a prismatic guide line of the first prismatic joint 310 in an initial state, α₂ is a rotation angle from the global X of a prismatic guide line of the second prismatic joint 320 in an initial state, α₃ is a rotation angle from the global X of a prismatic guide line of the third prismatic joint 330 in an initial state, α₄ is a rotation angle from the global X of a prismatic guide line of the fourth prismatic joint 340 in an initial state, and α₅ is a rotation angle from the global X of a prismatic guide line of the fifth prismatic joint 350 in an initial state. The above dimensions are given in an initial state. Parameters to be calculated along with movement of the apparatus may include a length δ₁ by which the second link 20 at an initial position is prismatic-guided from the third link 30 through the first prismatic joint 310, a length δ₂ by which the fifth link 50 at an initial position is prismatic-guided from the fourth link 40 through the second prismatic joint 320, a length δ₃ by which the third link 30 at at an initial position is prismatic-guided from the eighth link 80 through the third prismatic joint 330, a length δ₄ by which the second link 20 at at an initial position is prismatic-guided from the sixth link 60 through the fourth prismatic joint 340, and a length δ₅ by which the second link 20 is prismatic-guided from the seventh link 70 through the fifth prismatic joint 350. In addition, links connected via a prismatic joint are rotated at the same angle in an initial state, and thus, an angle at which the second link 20, the third link 30, the sixth link 60, the seventh link 70, and the eighth link 80 are rotated in an initial state may be referred to as θ₁, and an angle at which the fourth link 40 and the fifth link 50 are rotated in an initial state may be referred to as θₚ. In this case, the fourth link 40 may be connected with the first support 510 coupled to the proximal phalanx 910 of the wearer through the fixed joint 410, and thus, may be rotated at the same angle as a rotation angle θₚ of the proximal phalanx 910 of FIG. 1B.

In this case, a closed-loop equation of the fifth revolute joint 250, the fourth prismatic joint 340, the second revolute joint 220, the fifth prismatic joint 350, and the sixth revolute joint 260 may be Equation 3 below.

$${a}_{1} - {d}_{1} [ \begin{matrix}cos ( {θ}_{1} + {ϕ}_{1} ) \\ sin ( {θ}_{1} + {ϕ}_{1} )\end{matrix} ] + {d}_{3} [ \begin{matrix}cos ( {θ}_{1} + {ϕ}_{3} ) \\ sin ( {θ}_{1} + {ϕ}_{3} )\end{matrix} ] + {δ}_{4} [ \begin{matrix}cos ( {θ}_{1} + {α}_{4} ) \\ sin ( {θ}_{1} + {α}_{4} )\end{matrix} ] - {δ}_{5} [ \begin{matrix}cos ( {θ}_{1} + {α}_{5} ) \\ sin ( {θ}_{1} + {α}_{5} )\end{matrix} ] - {a}_{2} = 0 \qquad [ Equation 3 ]$$

A closed-loop equation of the fifth revolute joint 250, the fourth prismatic joint 340, the second revolute joint 220, the first prismatic joint 310, the third revolute joint 230, the third prismatic joint 330, and the first revolute joint 210 may be Equation 4 below.

$${a}_{1} - {d}_{1} [ \begin{matrix}cos ( {θ}_{1} + {ϕ}_{1} ) \\ sin ( {θ}_{1} + {ϕ}_{1} )\end{matrix} ] + {d}_{2} [ \begin{matrix}cos ( {θ}_{p} + {ϕ}_{2} ) \\ sin ( {θ}_{p} + {ϕ}_{2} )\end{matrix} ] - {d}_{4} [ \begin{matrix}cos ( {θ}_{1} + {ϕ}_{4} ) \\ sin ( {θ}_{1} + {ϕ}_{4} )\end{matrix} ] + {δ}_{4} [ \begin{matrix}cos ( {θ}_{1} + {α}_{4} ) \\ sin ( {θ}_{1} + {α}_{4} )\end{matrix} ] - {δ}_{1} [ \begin{matrix}cos ( {θ}_{1} + {α}_{1} ) \\ sin ( {θ}_{1} + {α}_{1} )\end{matrix} ] - {δ}_{3} [ \begin{matrix}cos ( {θ}_{1} + {α}_{3} ) \\ sin ( {θ}_{1} + {α}_{3} )\end{matrix} ] - {a}_{3} = 0 \qquad [ Equation 4 ]$$

A closed-loop equation of the fifth revolute joint 250, the fourth prismatic joint 340, the second revolute joint 220, the second prismatic joint 320, the third revolute joint 230, the third prismatic joint 330, and the first revolute joint 210 may be Equation 5 below.

$${a}_{1} - {d}_{1} [ \begin{matrix}cos ( {θ}_{1} + {ϕ}_{1} ) \\ sin ( {θ}_{1} + {ϕ}_{1} )\end{matrix} ] + {d}_{2} [ \begin{matrix}cos ( {θ}_{p} + {ϕ}_{2} ) \\ sin ( {θ}_{p} + {ϕ}_{2} )\end{matrix} ] - {d}_{4} [ \begin{matrix}cos ( {θ}_{1} + {ϕ}_{4} ) \\ sin ( {θ}_{1} + {ϕ}_{4} )\end{matrix} ] + {δ}_{4} [ \begin{matrix}cos ( {θ}_{1} + {α}_{4} ) \\ sin ( {θ}_{1} + {α}_{4} )\end{matrix} ] + {δ}_{2} [ \begin{matrix}cos ( {θ}_{p} + {α}_{2} ) \\ sin ( {θ}_{p} + {α}_{2} )\end{matrix} ] - {δ}_{3} [ \begin{matrix}cos ( {θ}_{1} + {α}_{3} ) \\ sin ( {θ}_{1} + {α}_{3} )\end{matrix} ] - {a}_{3} = 0 \qquad [ Equation 5 ]$$

That is, when a rotation angle θₚ is given, values δ₁, δ₂, δ₃, δ₄, δ₅, and θ₁ may be calculated through three equations of Equation 3, Equation 4, and Equation 5 above and movement of a 8-bar linkage mechanism may be recognized.

In this case, as a rotation angel θₚ is changed, the instrument may be moved, and the determined positions of the fixed joint 410 and the fourth revolute joint 240 may be calculated according to Equation 6 below and Equation 7 below, respectively.

$$\begin{matrix}{a}_{1} - {d}_{1} [ \begin{matrix}cos ( {θ}_{1} + {ϕ}_{1} ) \\ sin ( {θ}_{1} + {ϕ}_{1} )\end{matrix} ] + {δ}_{4} [ \begin{matrix}cos ( {θ}_{1} + {α}_{4} ) \\ sin ( {θ}_{1} + {α}_{4} )\end{matrix} ] + {d}_{5} [ \begin{matrix}cos ( {θ}_{p} + {ϕ}_{5} ) \\ sin ( {θ}_{p} + {ϕ}_{5} )\end{matrix} ] & [ Equation 6 ] \\ {a}_{1} - {d}_{1} [ \begin{matrix}cos ( {θ}_{1} + {ϕ}_{1} ) \\ sin ( {θ}_{1} + {ϕ}_{1} )\end{matrix} ] + {δ}_{4} [ \begin{matrix}cos ( {θ}_{1} + {α}_{4} ) \\ sin ( {θ}_{1} + {α}_{4} )\end{matrix} ] + {d}_{2} [ \begin{matrix}cos ( {θ}_{p} + {ϕ}_{2} ) \\ sin ( {θ}_{p} + {ϕ}_{2} )\end{matrix} ] + {δ}_{2} [ \begin{matrix}cos ( {θ}_{p} + {α}_{2} ) \\ sin ( {θ}_{p} + {α}_{2} )\end{matrix} ] + {d}_{6} [ \begin{matrix}cos ( {θ}_{1} + {α}_{6} ) \\ sin ( {θ}_{1} + {α}_{6} )\end{matrix} ] & [ Equation 7 ]\end{matrix}$$

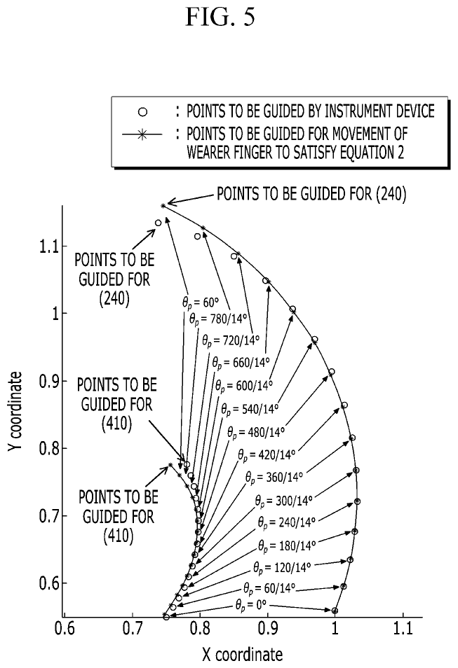

FIG. 5 shows comparison between a path drawn by the fixed joint 410 and the fourth revolute joint 240 that are calculated with respect to

$${θ}_{p} = 0 , \frac{60}{14} ° , \frac{120}{14} ° , \frac{180}{14} ° , \frac{240}{14} ° , \frac{300}{14} ° , \frac{360}{14} ° , 30 ° , \frac{480}{14} ° , \frac{540}{14} ° , \frac{600}{14} ° , \frac{660}{14} ° , \frac{720}{14} ° , \frac{780}{14} ° , 60 °$$

and a path by which movement of the wearer finger satisfies Equation 2 above through a numerical method with respect to an instrument with the dimensions of Table 1 above.

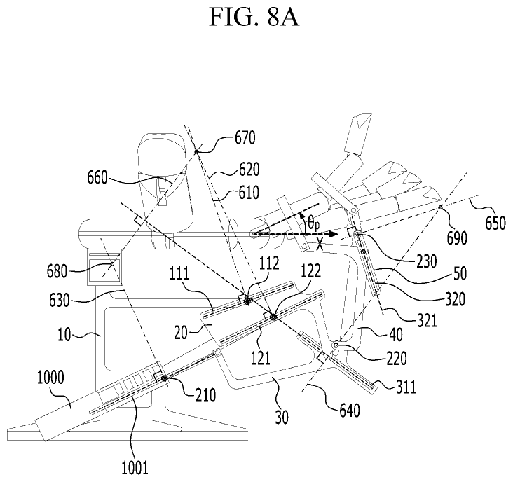

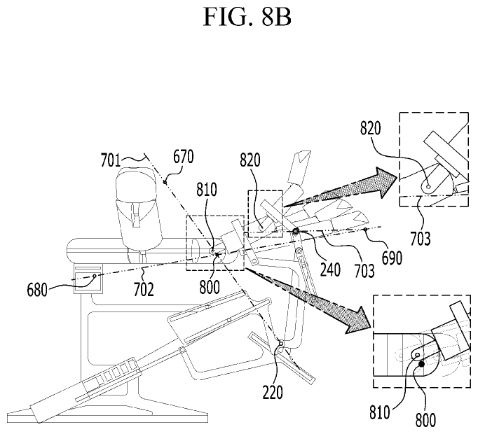

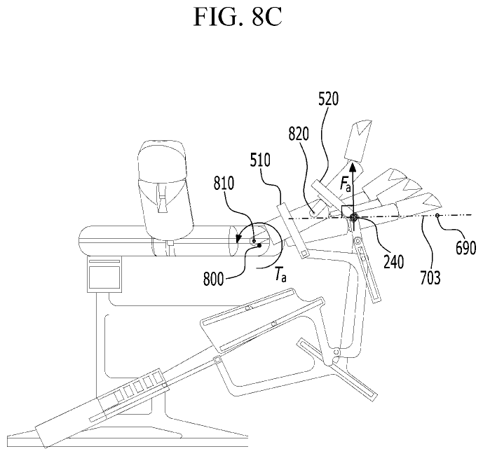

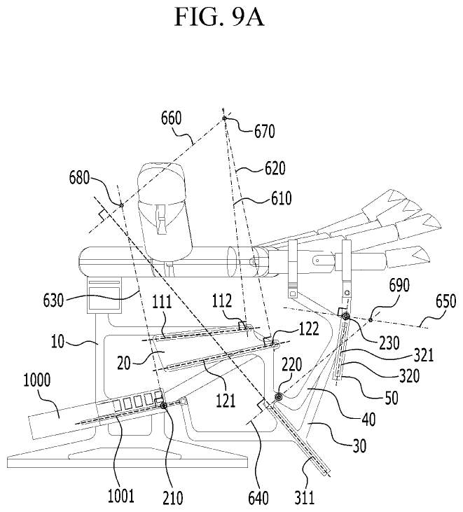

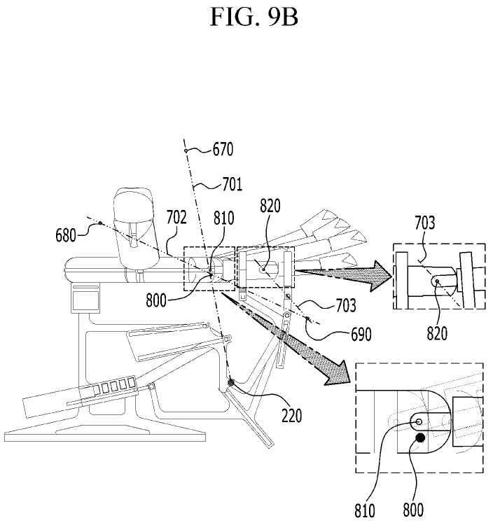

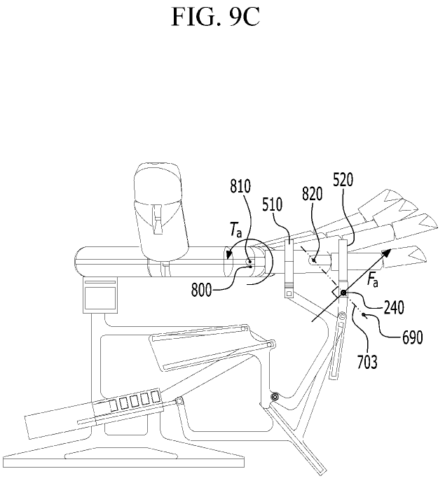

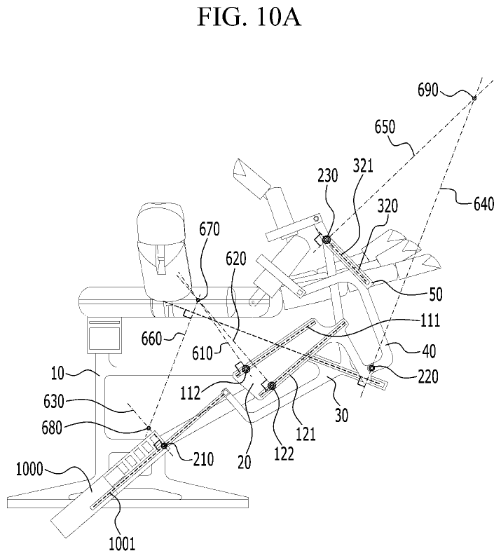

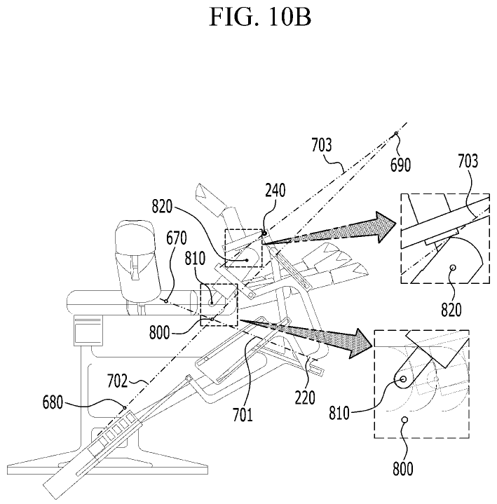

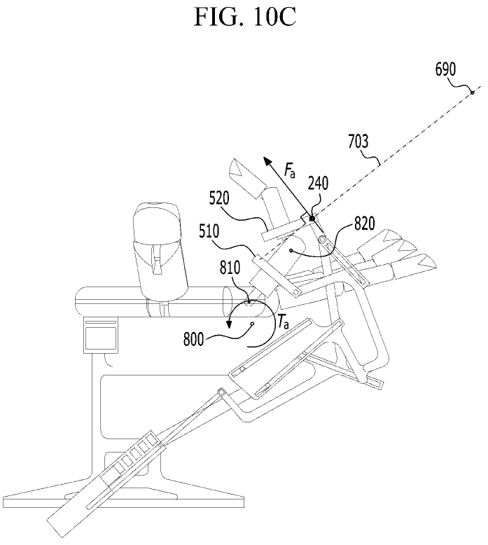

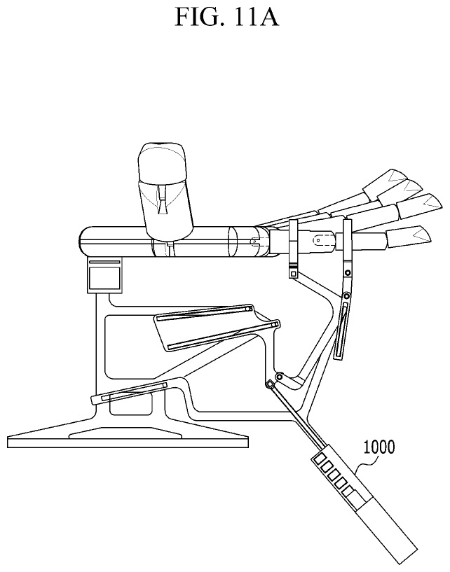

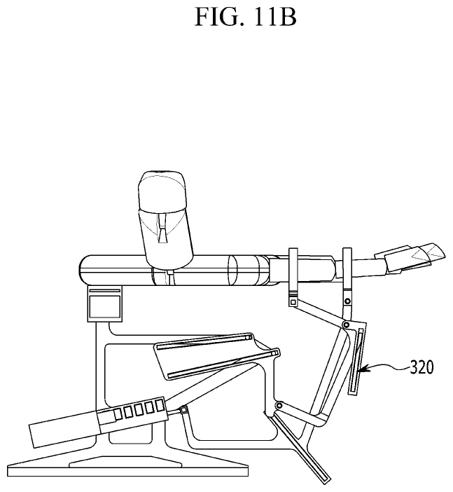

It may be seen that the paths are similar. Force may be appropriately transmitted along the path, which is described with reference to FIG. 8A, FIG. 8B, FIG. 8C, FIG. 9A, FIG. 9B, FIG. 9C, FIG. 10A, FIG. 10B, and FIG. 100.

FIG. 6 shows a linkage mechanism that has the same relationship (phase) but has fewer components than the linkage mechanism of FIG. 2. To reduce the number of manufactured components in FIG. 2, the sixth link 60 and the seventh link 70 among links with a revolute joint and a prismatic joint as opposite ends may be replaced with a first pin-in-slot joint 110 and a second pin-in-slot joint 120 of FIG. 6. Here, the pin-in-slot joint refers to a joint in which a slot of one link is coupled to a slot of another link. The first pin-in-slot joint 110 may include the sixth link 60 having opposite ends that are connected with the fifth revolute joint 250 and the fourth prismatic joint 340, respectively. The second pin-in-slot joint 120 may include the seventh link 70 having opposite ends that are connected with the sixth revolute joint 260 and the fifth prismatic joint 350, respectively. Movement of 2 degrees of freedom of rotation movement and translational movement between two links connected with each other through a pin-in-slot joint may be permitted. For example, any link with opposite ends connected through the revolute joint and the prismatic joint may be replaced with a pin-in-slot joint. For example, the fifth link 50, the third revolute joint 230, and the second prismatic joint 320 of FIG. 6 may be replaced with a pin-in-slot joint.

FIG. 7 is a diagram showing the finger rehabilitation exercise guide apparatus of FIG. 6 according to an exemplary embodiment of the present invention, and shows an embodiment in which the third prismatic joint 330 of FIG. 6 is replaced with the linear actuator 1000. As such, the linear actuator 1000 may be applied to exert driving force to the user finger. One side of the linear actuator 1000 may be connected to the first link 10 through the first revolute joint 210, and the other side of the linear actuator 1000 may be connected and may be rigidly-coupled to the third link 30 through the second fixed joint 420. Although FIG. 7 illustrates the case in which the apparatus is coupled to a robot finger, the apparatus may also be worn on an actual human finger.

In addition, FIG. 7 shows an embodiment in which the dimensions of FIG. 4 and Table 1 are applied. An angle of a slot of the first pin-in-slot joint 110 of FIG. 7 may be an angle α₄ of the fourth prismatic joint 340 of FIG. 4, a position of a pin of the first pin-in-slot joint 110 of FIG. 7 may be a position α₁ of the fifth revolute joint 250 of FIG. 4, an angle of a slot of the second pin-in-slot joint 120 of FIG. 7 may be an angle α₅ of the fifth prismatic joint 350 of FIG. 4, a position of a pin of the second pin-in-slot joint 120 of FIG. 7 may be a position α₂ of the sixth revolute joint 260 of FIG. 4, an angle of a driving direction of the linear actuator 1000 of FIG. 7 may be an angle α₃ of the third prismatic joint 330 of FIG. 4, and dimensions of the remaining components common to FIG. 4 are the same as dimensions shown in Table 1.

FIG. 8A, FIG. 8B, and FIG. 8C are diagrams showing an instantaneous center of rotation in the case when θₚ=25° is analyzed. Referring to FIG. 8A, the 21^{st} instantaneous center of rotation 670 with respect to the first link 10 of the second link 20 may be an intersection point between the first vertical line 610 perpendicular to a first center line 111 and passing through a first pin 112 of the first pin-in-slot joint 110, and the second vertical line 620 perpendicular to a second center line 121 and passing through a second pin 122 of the second pin-in-slot joint 120. A 31^{st} instantaneous center of rotation 680 with respect to the first link 10 of the third link 30 may be an intersection point between a third vertical line 630 passing through the first revolute joint 210 and perpendicular to a driving direction line 1001 of the linear actuator 1000, and a fourth vertical line 660 passing through the 21^{st} instantaneous center of rotation 670 and perpendicular to a first translational movement line 311 of the first prismatic joint 310. A 43^{rd} instantaneous center of rotation 690 with respect to the third link 30 of the fourth link 40 may be an intersection point between a fifth vertical line 650 passing through the third revolute joint 230 and perpendicular to a second translational movement line 321 of the second prismatic joint 320 and a sixth vertical line 640 passing through the second revolute joint 220 and perpendicular to the first translation movement line 311 of the first prismatic joint 310. Referring to FIG. 8B, a 41^{st} instantaneous center of rotation 800 with respect to the first link 10 of the fourth link 40 may be positioned on a first imaginary line 702 for connection of the 31^{st} instantaneous center of rotation 680 with respect to the first link 10 of the third link 30 with the 43^{rd} instantaneous center of rotation 690 with respect to the third link 30 of the fourth link 40. The 41^{st} instantaneous center of rotation 800 may be positioned on a second imaginary line 701 for connection of a 42^{nd} instantaneous center of rotation 220 with respect to the second link 20 of the fourth link 40 with the 21^{st} instantantaneous center of rotation 670 with respect to the first link 10 of the second link 20. That is, the 41^{st} instantaneous center of rotation 800 with respect to the first link 10 of the fourth link 40 may be an intersection point between the first imaginary line 702 and the second imaginary line 701. Similarly, as seen from FIG. 9A, FIG. 9B, and FIG. 9C (θₚ=0°) and FIG. 10A, FIG. 10B, and FIG. 100 (θₚ=50°), the 41^{St} instantaneous center of rotation 800 with respect to the first link 10 of the fourth link 40 is also positioned around the first joint (MCP) 810 of the user.

As seen from FIG. 8B, FIG. 9B, and FIG. 10B, a third imaginary line 703 for connection of the 43^{rd} instantaneous center of rotation 690 that is an instantaneous center of rotation with respect to the third link 30 of the fourth link 40 with the fourth revolute joint 240 may pass around the second joint (PIP) 820 of the user.

FIG. 8C, FIG. 9C, and FIG. 100 show moment Tₐ transmitted to the first support 510 from the first link 10 and force Fₐ transmitted to the finger of a wearer to the second support 520 from the second support 520 in the case of θₚ=25°, θₚ=0°, and θₚ=50°, respectively. The moment Tₐ may be applied to the first segment (proximal phalanx) 910 based on the 41^{st} instantaneous center of rotation 800, and the 41^{st} instantaneous center of rotation 800 may be positioned around the first joint (MCP) 810, and thus, it may be seen that Tₐ is similar to the appropriate T described with reference to FIG. 1B. The force Fₐ may be applied to the second segment (intermediate phalanx) 920 of the wearer in a direction passing through the fourth revolute joint 240 and perpendicular to the third imaginary line 703, and the third imaginary line 703 passes around the second joint 820 of the wearer, and thus, it may be seen that Fₐ is similar to the appropriate Fₙ described with reference to FIG. 1B.

According to the embodiments using the above dimensions, since the finger of the wearer and the apparatus do not interfere with each other within a driving range, it may be possible to drive the apparatus and a small thickness may be maintained, and thus the apparatus may be simultaneously worn on a plurality of fingers of the user.

That is, the present invention may include any dimension that the 41^{st} instantaneous center of rotation 800 with respect to the first link 10 of the fourth link 40 is adjacent to the first joint (MCP) 810 of the wearer and the third imaginary line 703 for connection of the instantaneous center of rotation 690 with respect to the fourth link 40 of the third link 30 with the fourth revolute joint 240 is adjacent to the second joint (PIP) 820 of the wearer.

The finger rehabilitation exercise guide apparatus according to an exemplary embodiment of the present invention may include eight links disposed in different shapes, and connection joints connected to the eight links, respectively, to form an 8-bar linkage with 1 degree of freedom. Here, the connection joint may include six revolute joints and five prismatic joints and may be selectively coupled to eight link connection parts to freely change a position of a prismatic joint while maintaining a path for guiding the finger. Here, the prismatic joint may be replaced with the linear mechanical component, and as necessary, one of the revolute joint and the prismatic joint may be replaced with an actuator. In addition, other mechanical components such as a spring or a damper may be added to a position of a revolute joint or a prismatic joint or may replace corresponding joints, according to the characteristics of the component.

FIG. 11A and FIG. 11B are diagrams showing other exemplary embodiments that are different from FIG. 7. FIG. 11A shows an embodiment in which the eighth link 80, the third prismatic joint 330, and the first revolute joint 210 are replaced with a third pin-in-slot joint 130, and the linear actuator 1000 is connected with the third link 30 and the second link 20 through a fixed joint and replace the first prismatic joint 310 in the embodiment of FIG. 6. FIG. 11B shows an embodiment in which a position of the second prismatic joint 320 is changed in the embodiment of FIG. 7.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 10: first link | 20: second link |
| 30: third link | 40: fourth link |
| 50: fifth link | 60: sixth link |
| 70: seventh link | 80: eighth link |
| 110: first pin-in-slot joint | 120: second pin-in-slot joint |
| 210: first revolute joint | 220: second revolute joint |
| 230: third revolute joint | 240: fourth revolute joint |
| 250: fifth revolute joint | 260: sixth revolute joint |
| 310: first prismatic joint | 320: second prismatic joint |
| 330: third prismatic joint | 340: fourth prismatic joint |
| 350: fifth prismatic joint | 510: first support |
| 520: second support | |

What is claimed is:

1. A finger rehabilitation exercise guide apparatus comprising:
a first support coupled to a proximal phalanx positioned between a first joint (metacarpophalangeal (MCP)) and a second joint (proximal interphalangeal (PIP)) of a finger with three joints and three segments;
a second support coupled to a intermediate phalanx positioned between the second joint and a third joint (distal interphalangeal (DIP));
a first link having one side supporting a hand with fingers and the other side supported by a palm and functioning as a reference with respect to overall movement of a link structure;
an actuator for generating driving force transmitted to the first support and the second support from the first link;
a first transmitter including a plurality of links connected with each other in different shapes between the first support and the first link, some revolute joint of a plurality of revolute joints, and a plurality of prismatic joints, and transmitting the driving force of the actuator to the first support; and
a second transmitter for sharing the plurality of links connected with each other between the second support and the first link, a plurality of revolute joints, and the plurality of prismatic joints, and transmitting the driving force of the actuator to the second support,
wherein the plurality of links include:
a second link having one side coupled to a sixth link through a fourth prismatic joint, another side coupled to a seventh link through a fifth prismatic joint, another side coupled to a third link through a first prismatic joint, and another side coupled to a fourth link through a second revolute joint;
a third link having one side coupled to a second link through a first prismatic joint, another side coupled to the second support through a fourth revolute joint, and another side coupled to an eighth link through a third prismatic joint;
a fourth link having one side coupled to the second link through the second revolute joint, another side coupled to the first support through a fixed joint, and another side coupled to a fifth link through a second prismatic joint,
a fifth link having one side coupled to the fourth link through a second prismatic joint and the other side coupled to the third link through a third revolute joint;
a sixth link having one side coupled to the first link through a fifth revolute joint and the other side coupled to the second link through the fourth prismatic joint;
a seventh link having one side coupled to the first link through a sixth revolute joint and the other side coupled to the second link through a fifth prismatic joint; and
an eighth link having one side coupled to the first link through a first revolute joint and the other side coupled to the third link through a third prismatic joint.

2. The finger rehabilitation exercise guide apparatus of claim 1, wherein
the plurality of revolute joints include the first revolute joint for connection of the first link and the eighth link, the second revolute joint for connection of the second link and the fourth link, the third revolute joint for connection of the third link and the fifth link, the fourth revolute joint for connection of the third link and the second support, the fifth revolute joint for connection of the first link and the sixth link, and the sixth revolute joint for connection of the first link and the seventh link.

3. The finger rehabilitation exercise guide apparatus of claim 2, wherein
the plurality of prismatic joints include the first prismatic joint for connection of the third link and the second link, the second prismatic joint for connection of the fourth link and the fifth link, the third prismatic joint for connection of the third link and the eighth link, the fourth prismatic joint for connection of the second link and the sixth link, and the fifth prismatic joint for connection of the second link and the seventh link.

4. The finger rehabilitation exercise guide apparatus of claim 3, wherein
the revolute joint and the prismatic joint connected with a link having opposite sides that are coupled to other links through a revolute joint and a prismatic joint, respectively, are formed as pin-in-slot joints.

5. The finger rehabilitation exercise guide apparatus of claim 4, wherein
the pin-in-slot joint includes:
a first pin-in-slot joint in which a first pin included in the first link is coupled to a first slot included in the second link;
a second pin-in-slot joint in which a second pin included in the first link is coupled to a second slot included in the second link;
a third pin-in-slot joint in which a third pin included in the first link is coupled to a third slot included in the third link; and
a fourth pin-in-slot joint in which a fourth pin included in the third link is coupled to a fourth slot included in the fourth link.

6. The finger rehabilitation exercise guide apparatus of claim 5, wherein
the first pin-in-slot joint includes the sixth link, the fifth revolute joint, and the fourth prismatic joint.

7. The finger rehabilitation exercise guide apparatus of claim 5, wherein
the second pin-in-slot joint includes the seventh link, the sixth revolute joint, and the fifth prismatic joint.

8. The finger rehabilitation exercise guide apparatus of claim 5, wherein
the third pin-in-slot joint includes the eighth link, the first revolute joint, and the third prismatic joint.

9. The finger rehabilitation exercise guide apparatus of claim 5, wherein
the fourth pin-in-slot joint includes the fifth link, the third revolute joint, and the second prismatic joint.

10. The finger rehabilitation exercise guide apparatus of claim 3, wherein
some of revolute joints, prismatic joints, and links that are selected from the plurality of revolute joints, the plurality of prismatic joints, and a plurality of links connected with the plurality of revolute joint or the plurality of prismatic joints are formed as an actuator.

11. The finger rehabilitation exercise guide apparatus of claim 10, wherein
the first prismatic joint is formed as a linear actuator having one side coupled to the second link through a fixed joint and the other side coupled to the third link through the fixed joint.

12. The finger rehabilitation exercise guide apparatus of claim 10, wherein
the first revolute joint and the eighth link are formed as a rotary actuator having one side coupled to the first link through the fixed joint and the other side coupled to the third link through the third prismatic joint.

13. The finger rehabilitation exercise guide apparatus of claim 3, further comprising
a linear spring and a linear damper coupled to a prismatic joint selected from the plurality of prismatic joints.

14. The finger rehabilitation exercise guide apparatus of claim 3, further comprising
a rotation spring and a rotation damper coupled to a revolute joint selected from the plurality of revolute joints.

15. The finger rehabilitation exercise guide apparatus of claim 3, wherein
an instantaneous center of rotation with respect to the first link of the fourth link coupled to the first support through the fixed joint is adjacent to the first joint in a predetermined driving range.

16. The finger rehabilitation exercise guide apparatus of claim 15, wherein
a straight line for connection of an instantaneous center of rotation with respect to the fourth link of the third link coupled to the second support through the fourth revolute joint with the fourth revolute joint is adjacent to the second joint in a predetermined driving range.
